(19) United States
(12) Patent Application Publication
(10) Pub. No.: US 2021/0271989 A1
(43) Pub. Date: Sep. 2, 2021

(54) METHOD FOR PREDICTING VESSEL DENSITY IN A SURVEILLANCE AREA

(71) Applicant: VIETTEL GROUP, Ha Noi City (VN)

(72) Inventors: Van Tuan Nguyen, Dien Chau District (VN); Gia Thinh Nguyen, Ho Chi Minh City (VN); Dinh Bao Khang Nguyen, Ho Chi Minh City (VN)

(73) Assignee: VIETTEL GROUP, Ha Noi City (VN)

(21) Appl. No.: 17/122,807

(22) Filed: Dec. 15, 2020

(30) Foreign Application Priority Data
Feb. 28, 2020 (VN) 1-2020-01149

(51) Int. Cl. G06N 5/04; G08G 3/00; G06N 20/00

(52) U.S. Cl. CPC G06N 5/04; G06N 20/00; G08G 3/00

(57) ABSTRACT

The target density prediction method by area comprises of 4 main steps: Step 1: preparing training dataset; Step 2: analyzing time series characteristics of training dataset; Step 3: training the autoregressive integrated moving average model; Step 4: predicting the target density over a defined time period in the future. The chosen method technically analyzes the time series characteristics of historical dataset by monitoring areas, and determines the cycle property, parameters and the autoregressive integrated moving average model to predict the number of targets that have high probability appearing in monitoring area at some point in the future.

### TECHNICAL ASPECTS OF THE INVENTION

The following invention aims to introduce a prediction method for vessel density within specific areas. In detail, the prediction method has practical application in many analyzing systems and monitoring systems which keep track of target ships' operation in a region, which supports the operators with early detection and warning alert of possibility of various types of situations, thus provides proper solutions to handle the incoming incidents in time.

### BACKGROUND OF THE INVENTION

Nowadays, original methods indicating the density of ship are usually based on vessel number statistical techniques over a predefined time period with pre-archived data. Those methods are only statistically based on historical data, but do not have the process of predicting the number of ships in specified regions given a specified time duration. This invention proposes a solution to automatically forecast the number of ship targets that are likely to occur in the surveillance area with small errors. In addition, the method assists observers to analyze and identify possible scenarios based on the vessel density in an area at a future point in time.

### SUMMARY OF THE INVENTION

The purpose of proposed invention is to predict ship target density by region. The prediction method is performed through the following steps:
Step 1: preparing training data
Step 2: analyzing time series of training dataset
Step 3: training Autoregressive Integrated Moving Average model
Step 4: predicting the target density given a specified future point in time.

The proposed prediction method is based on time series analysis technique and ARIMA model, which is used to predict the number of ship targets that are likely to appear in a particular area based on the historical data of location information collected by reconnaissance systems and specialized monitors. The method analyzes the time series characteristics of historical data with respect to the monitoring area, thereby determines the periodicity, parameters and the models to predict the quantity of targets likely to appear in a surveillance area in the future.

The utilized data is AIS (Automatic Identification System), which is the transmitted data type between AIS devices. In detail, the MMSI (Maritime Mobile Service Identity) field is used as a unique indicator representing a specific vessel. The number of vessels in an area is subsequently obtained by extracting the number of distinct vessels based on MMSI. The process of training, testing and predicting is performed on computer with following configuration: Intel Core i7-8700 CPU (12 cores), Quadro P4000 GPU, and memory of 32 GB.

### BRIEF DESCRIPTION OF THE DRAWINGS

FIG. 1 illustrates the flow diagram of the proposed forecasting method.

FIG. 2 presents a schematic drawing of steps and processes for training data preparation according to step 1 in technical nature of invention.

FIG. 3 shows the predicted targets density in a specific region in the time interval of 30 minutes.

### DETAILED DESCRIPTION OF THE PREFERRED EMBODIMENT

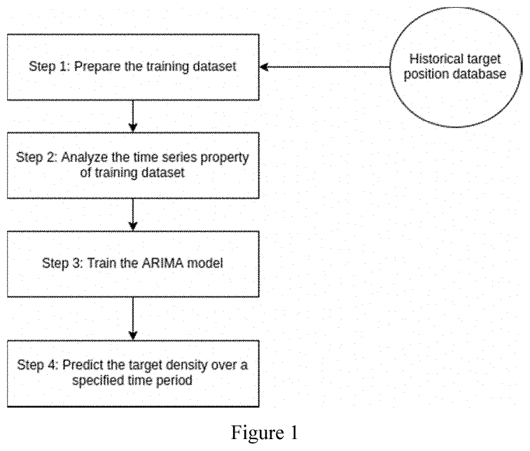

Refer to FIG. 1, the targets density prediction method by area is described and presented as the following steps:

Step 1: Training data preparation.

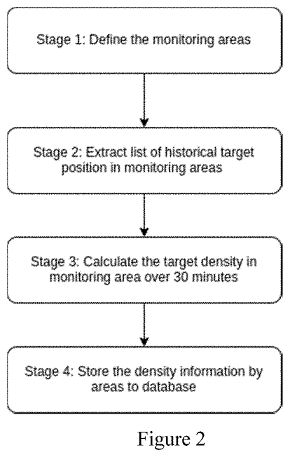

To achieve a prediction model with high confidence and small prediction error, processing of location dataset to determine the target density in the area in the past is the most important step. In order to perform the data preparation with high quality assurance for training the data, the authors have undergone the following four stages (illustrated in FIG. 2):

Stage 1: Define Density Monitoring Area.

Due to the monitoring characteristics of the target density, existing surveillance systems normally define polygonal or circular areas with corresponding parameters. This definition of area helps to reduce the complexity of the calculation, and increases the concentration while monitoring targets that appear in the area.

Stage 2: Extract List of Historical Position Data of Targets in Monitoring Area

From the historical target location dataset collected by monitoring systems, the procedure of processing data performs extraction of historical target locations in predefined areas at stage 1.

Stage 3: Calculate the Target Density in Observed Area with a Period of 30 Minutes

After extracting all historical target location data in defined area with respect to time, it is necessary to group and discard records with the same target identifier appearing at the same time and same considered region, In the scope of this invention, the time period is 30 minutes and the identifier being used is the MMSI (Maritime Mobile Service Identity) of vessel.

Stage 4: Storing target density information by regions in database.

The data processing procedure from stage 2 to stage 3 is continuous, so it is essential to store information about area, timestamp, corresponding location of each record in database for serving accessing when performing training prediction model in the next steps of the invention.

Step 2: Analyze time series properties of training dataset.

The output of this step is a reliable prediction model when analyzing stationary property of time series data prepared from step 1. As can be seen, the target density dataset extracted from step 1 is time-dependent dataset. Thus, it is mandatory to verify the stationary pattern of the dataset to decide a proper prediction model. A time series is stationary when the mean value, variance and covariance (at different time lag) remain constant regardless of time moment the time series that is specified, so stationary time series have the trend towards the mean value and fluctuation around mean value will be the same. In addition, analyzing stationary pattern of a time series aims to determine stability of the series. Subsequently, time series prediction model parameters can be selected and adjusted. In general, a time series can be described as follow:

(yₜ)_{-∞}^{+∞}=(y_{-∞}, . . . ,y₀,y₁,y₂, . . . ,yₙ, . . . )

A time series is stationary when its average value, variance and covariance at distinct time lags is persistent over time, in other words, irrespective of time.

E[yₜ]=μ,∀t

var(yₜ)=σ⁻²,∀t

cov(yₜ,yₜ₊ₖ)=γₖ,∀t

To determine whether a time series is stationary, different types of test and evaluation need to be performed. In the scope of this invention, the assessment to evaluate stationary property is ADF (Augmented Dickey—Fuller). This method represents time series yₜ as follow:

yₜ=ρyₜ₋₁+uₜ

with uₜ is an independent series sharing the same distribution with time series yₜ. In order to verify stationary pattern of time series yₜ, the following hypothesis pairs need to be verified:

H₀: ρ=1

H₁: ρ<1

with the assumption that H₀ is a non-stationary time series and H₁ is a stationary time series.

Consequently, statistical test T with Dickey—Fuller distribution has the following representation:

$$T = \frac{\hat{ρ} - 1}{S E ( \hat{ρ} )}$$

If |T|>|T_{α}|, then hypothesis H₀ is rejected and H₁ is accepted, which concludes that the time series is stationary.

Step 3: Training Autoregressive Integrated Moving Average Model

After defining that the time series of target density by area is stationary at step 2, the authors has chosen ARIMA (Autoregressive Integrated Moving Average) model for predicting the target density for the next time period. Since the time series for vessel target density is a stationary time series, and the model is independent of the change of time series, according to the statistical intervals, the choice of ARIMA based prediction method is considered appropriate. The ARIMA model comprises of two processes: self-regression and moving average. The next section will explain in more detail the processes and integrate these two processes into the prediction model.

Self Regression Process:

The initial time series yₜ is transformed into a p-order self regression process (denoted by AR (p) as follow:

yₜ=φ₀+φ₁yₜ₋₁+φ₂yₜ₋₂+ . . . +φₚyₜ₋ₚ+uₜ (1)

with φᵢ (i=0, . . . , p) are the parameters of the process, uₜ is the white noise with normal distribution N(0, σ²). Besides depending on white noise, yₜ also depends on its p latency.

Convert equation (1) into delay operator, we have:

(1−φ₁L−φ₂L²− . . . −φₚLₚ)yₜ=φ₀+uₜ

Let φ(L)=1−φ₁L−φ₂L²− . . . −φₚL^{p}, the above equation becomes:

φ(L)yₜ=φ₀+uₜ

The characteristic equation of AR(p) process is:

1−φ₁z−φ₂z²− . . . −φₚzₚ=0

The AR(p) process is stationary if and only if the solution of the feature equation is outside the unit circle, then we can obtain the corresponding parameters of AR(p) process as follow:

Mean Value:

$$E [ {y}_{t} ] = μ = \frac{{φ}_{0}}{1 - {φ}_{1} - {φ}_{2} - ⋯ - {φ}_{p}}$$

The correlation coefficient of the process determined after solving the Yule-Walker equation is:

$${γ}_{k} = \{ \begin{matrix}{φ}_{1} {γ}_{k - 1} + {φ}_{2} {γ}_{k - 2} + ⋯ + {φ}_{p} {γ}_{k - p} ( k = 1 , 2 , … ) \\ {φ}_{1} {γ}_{k - 1} + {φ}_{2} {γ}_{k - 2} + ⋯ + {φ}_{p} {γ}_{k - p} + {σ}^{2} ( k = 0 )\end{matrix}$$

Moving Average Process:

The initial time series yₜ is converted into a p-order moving average process (denoted by MA(q)) as follow:

yₜ=μ+uₜ+θ₁uₜ₋₁+θ₂uₜ₋₂+ . . . +θ_{q}u_{t-q} (2)

With μ is a constant, uₜ is white noise with normal distribution N(0, σ²) and θᵢ (i=1, . . . , q) is the parameters of the process.

From equation (2), the corresponding parameters of MA(q) can be determined as follow:

Mean Value:

E[yₜ]=μ

Variance:

var(yₜ)=(θ₁²+θ₂²+ . . . +θ_{q}²)σ²

Correlation Coefficient:

$${γ}_{k} = \{ \begin{matrix}{σ}^{2} {\sum }_{i = 0}^{q - k} {θ}_{i} {θ}_{i + k} ( k \leq q ) \\ 0 ( k > q )\end{matrix}$$

Autoregressive Integrated Moving Average Process:

The (p, q) order autoregressive integrated moving average process (denoted by ARMA(p, q)) is a combination of two separate processes AR(p) and MA(q), the general equation of the process is represented as follow:

yₜ=φ₀+φ₁yₜ₋₁+ . . . +φₚy_{t-q}+uₜ+θ₁uₜ₋₁+ . . . +θ_{q}u_{t-q}

Apply the delay operator transformation, the above equation becomes:

φ(L)yₜ=φ₀+θ(L)uₜ

with:

φ(L)=(1−φ₁L−φ₂L²− . . . −φₚL^{p})

θ(L)=(1+θ₁L+θ₂L²+ . . . +θ_{q}L^{q})

If the solution of the characteristic equation:

1−φ₁z−φ₂z²− . . . −φₚzₚ=0

is outside the unit circle, the general equation is represented as:

$${y}_{t} = {[ φ ( L ) ]}^{- 1} {φ}_{0} + ( \frac{1 + {θ}_{1} L + ⋯ + {θ}_{q} {L}^{q}}{1 - {φ}_{1} L - ⋯ - {φ}_{p} {L}^{p}} ) {u}_{t} = μ + ψ ( L ) {u}_{t}$$

with

$$μ = {[ φ ( L ) ]}^{- 1} {φ}_{0} = \frac{{φ}_{0}}{1 - {φ}_{1} - ⋯ - {φ}_{p}}$$

$$ψ ( L ) = \frac{1 + {θ}_{1} L + ⋯ + {θ}_{q} {L}^{q}}{1 - {φ}_{1} L - ⋯ - {φ}_{p} {L}^{p}} = 1 + {ψ}_{1} L + {ψ}_{2} {L}^{2} + {ψ}_{3} {L}^{3} + ⋯$$

$${\sum }_{k = 0}^{+ ∞} \vert {ψ}_{k} \vert < + ∞$$

Step 4: Predicting the Target Density Over a Defined Time Period in the Future

From the training dataset prepared in step 1, training the ARIMA model at step 3 is conducted, the prediction model includes the trained parameters from the dataset, and will be used for the process of predicting the value of vessel density for the next time period in the future. Assuming that we have a prediction model M trained with time series dataset to time t, the model M predicting the target density value at a time in the future can be shown as:

M:yₜ₊ₛ=f(yₜ,yₜ₋₁, . . . )

with s is the predicted time interval. In the scope of this invention, the prediction interval value is s=30 minutes.

From the predicted target density value by the time period s=30 minutes, in order to evaluate the accuracy of proposed prediction model, and consider as a basis for using prediction model in practice, the authors utilize the “symmetric percentage mean error” measure (referred as SMAPE) which has the following formula:

$$SMAPE = \frac{100 \%}{n} {\sum }_{t = 1}^{n} \frac{\vert {F}_{t} - {A}_{t} \vert}{\frac{\vert {A}_{t} \vert + \vert {F}_{t} \vert}{2}}$$

in which, Aₜ is the true target density value, Fₜ is the predicted target density value at a time in the future.

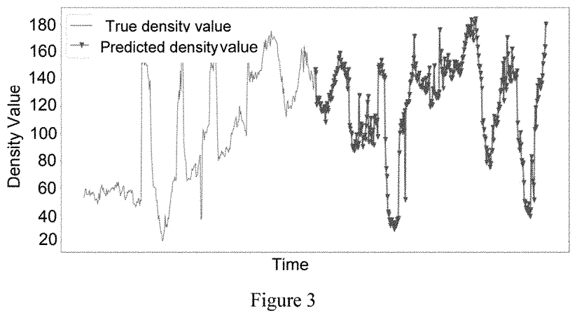

FIG. 3 shows the resulting graph of predicted target density value compared with true target density value over a one-week period with a 30-minute sampling period of a specified area with SMAPE=0.93%.

What is claimed is:

1. A target density prediction method by specific region comprises the following steps:
Step 1: preparing training data; in this step, 4 stages is carried out respectively:
Stage 1: define a monitoring density area; to reduce a complexity of calculation, and increase a concentration when monitoring a target appearing in the areas;
Stage 2: extracting a list of historical position of targets in the monitoring area;
Stage 3: calculating a target density in the monitoring areas over a period of 30 minutes, after extracting all of the historical position data in the specified area by time, group and omit records that share a same identifier information and appear at a same considered time period, and a same considered area;
Stage 4: storing the target density information by region in a database;
Step 2: analyze a time series of training data, in order to decide whether the time series is stationary, use an ADF test (Augmented Dickey-Fuller) to assess and represent the time series yₜ as follows:
yₜ=ρyₜ₋₁+uₜ
with uₜ is the independent series with a same distribution as time series yₜ, to test the stationary characteristics of time series yₜ, the following assumption needs to be tested:
H₀: ρ=1
H₁: ρ<1
with the assumption that v is a non-stationary time series and H₁ is a stationary time series.
From that, a statistical inspection T with the Dickey—Fuller distribution has the following representation:
$$T = \frac{\hat{ρ} - 1}{S E ( \hat{ρ} )}$$
if |T|>|T_{α}|, the hypothesis H₀ is omitted and H₁ is approved, which resolves that the series is stationary,
Step 3: training an autoregressive integrated moving average; At this step, after defining the time series of target density by region is a stationary series at step 2, an ARIMA model is adopted for forecasting a target density over a next time interval;
Step 4: predicting a target density value given a discrete time period in the future; At this step, training the prediction model of step 3 is conducted with training dataset prepared from step 1, predict a vessel target density at a next time period in the future, Assuming that we have a prediction model M trained with time series dataset to time t, a representation of prediction model M at a time in the future is:
M: yₜ₊ₛ=f(yₜ,yₜ₋₁, . . . ).
